(19) United States
(12) Patent Application Publication
(10) Pub. No.: US 2008/0263883 A1
(43) Pub. Date: Oct. 30, 2008

(54) COLLAPSIBLE AVALANCHE PROBE

(75) Inventors: Andre Poulheim, Koln (DE); Thorsten Frackenpohl, Koln (DE)

Correspondence Address: MICHAEL J. WEINS, 31 BANK STREET, LEBANON, NH, 03766, US

(73) Assignee: Gerald KAMPEL, Taufkirchen (DE)

(21) Appl. No.: 11/462,519

(22) Filed: Aug. 4, 2006

(30) Foreign Application Priority Data
Aug. 8, 2005 (DE) 10 2005 037 390

(51) Int. Cl. G01V 9/00; G01N 3/42; G01N 3/54; G01F 23/04; G01B 5/18

(52) U.S. Cl. 33/559; 33/713; 116/205; 73/85

(57) ABSTRACT

An avalanche probe for locating and rescuing people buried by an avalanche is collapsible, having several probe segments which allow the probe to be folded to a compact unit that can be quickly and easily assembled for use. A connecting cord passes through the probe segments and fastens to a probe tip. Applying tension to the cord draws the segments into alignment. A clamping mechanism maintains the tension on the cord in such a manner that the probe segments are fixedly and securely held against one another. The clamping mechanism provides two interpenetrating elements, an outer element and an inner element having a passage therethrough. At least one clamping element passes into the central passage and is forcibly engaged with the cord as the interpenetration of the elements increases.

### FIELD OF THE INVENTION

The present invention relates to a collapsible avalanche probe for probing for people buried by an avalanche.

### BACKGROUND OF THE INVENTION

Collapsible avalanche probes are known, inter alia, from publication DE 37 29 058 A1. They are employed for probing the relevant terrain after the descent of an avalanche that has buried people. The use of avalanche probes allows the location of an avalanche victim to be pinpointed, particularly in short-range searches. Thus, since the exact position of the buried person has already been determined, an exhausting and time-consuming digging away of snow can be avoided when the avalanche victim is rescued by means of an avalanche shovel.

Collapsible avalanche probes, which usually consist of a plurality of tubular probe parts that can be assembled when needed, have the advantage that they can be reduced to a very compact pack size when not in use. Since this allows the otherwise bulky avalanche probe to be easily stowed away, this is particularly advantageous for winter sportsmen who carry the avalanche probe solely for the case of an emergency that will hopefully never occur.

One example of such a collapsible avalanche probe is shown in FIG. 1. The avalanche probe consists of several tubular probe parts (10, 11, 12) having a connecting cord 2 running therethrough. The connecting cord 2 is usually fastened to the tip 1 of the avalanche probe and can be tensioned by means of a tensioning apparatus 3 at the end of the probe opposite the tip 1 such that the individual probe parts (10, 11, 12) line up against one another. Plug connections 13 between neighboring probe parts (10, 11, 12) guide the probe parts (10, 11, 12) into alignment and provide additional stability. To ensure permanent connection of the probe parts (10, 11, 12), even when probing in snow, is necessary to fix the tensioned connecting cord 2 to prevent the probe parts (10, 11, 12) from pulling apart. A rudimentary scheme for fixing the connecting cord is taught in French publication nos. 2,583,986, where the cord is tied to a cleat mounted to the one of the probe parts. However, it is preferred to fix the connecting cord 2 by use of a clamping apparatus 20 mounted to the last probe part 10, which is the part most distant from the probe tip 1.

One conventional approach to fixing the connecting cord 2 when tensioned is to provide a threaded tension rod on the last probe part 10. When the avalanche probe is in a folded state, this tension rod is situated within the last probe part 10, with one end protruding from the last probe part 10 only a little bit. The connecting cord 2 is attached to the other end of the tension rod. By pulling out the tension rod, the connecting cord 2 is tensioned. The tension rod is dimensioned such that a thread on the rod engages a nut provided for this purpose on the last probe part 10 just as the connecting cord 2 is sufficiently tensioned and holds the probe parts (10, 11, 12) together. Via a rotational motion of the tension rod around its own axis, its thread can be screwed into the nut, and the connecting cord 2 can thus be fixed in a tensioned state. This apparatus exhibits several disadvantages. On the one hand, the thread as well as the tension rod protruding from the last probe part are subject to heavy wear. The rod can bend and hamper the assembly and disassembly of the probe. Similarly, the thread of both the nut and the tension rod can be damaged due to corrosion or other mechanical influences. Similarly, the thread frequently fails to function under the extreme conditions of ice and snow. Finally, the screwing in of the tension rod into the nut sphere in severe cold with stiff, glove-protected hands can be difficult.

To help overcome the difficulty in operating a clamping apparatus such as described above, DE 37 29 058 A1 of the present inventor teaches two structures for fixing the tensioned cord more easily. In a first clamping apparatus, shown in FIG. 2 of the reference, a nut is provided having a non-axial thread such that the nut can be tilted with respect to the last probe part and pulled, then realigned with the last probe part and threadably tightened to fix the connecting cord. The ability to tilt the nut and pull it speeds the fixing procedure, as the nut need not be turned along the full thread range. However, the threads may become disengaged if the nut is inadvertently titled when the probe is in use. In another clamping apparatus, shown in FIG. 3 of the reference, a knot on the connecting cord is pulled into a notch and a cam lever is activated to force the notched part so as to securely tension the connecting cord. While these clamping devices are easier to manipulate than the tension rod discussed above, they still require considerable manipulation to operate.

Another attempt to simplify fixing the tensioned connecting cord is taught in U.S. Pat. No. 5,966,992. The '992 patent teaches a clamping apparatus where a cable-engaging member is affixed to the connecting cord, and in turn is configured to engage a clamping member. A series of annular grooves on the cable-engaging member can be pulled through the clamping member to tension the connecting cord, but are prevented from moving in the other direction by a spring-loaded pressure member housed in the clamping member. Thus, the connecting cord is fixed automatically as it is pulled to tension it. While the '992 clamping apparatus may provide greater ease in fixing the connecting cord, it appears to do so at the expense of increased wear, as the tensioning force is offset on one side of the cord. The apparatus also may be subject to jamming due to buildup of ice or other foreign matter in the clamping mechanism; the '992 patent suggests that the annular grooves are prone to ice build-up, as it teaches that ice in the annular grooves is crushed by the spring-loaded pressure member; however, there is no discussion of other possible causes of jamming. Furthermore, the release lever moves normal to the probe axis and is exposed to possible inadvertent release.

### SUMMARY OF THE INVENTION

The present invention provides an avalanche probe that can be assembled, used and disassembled in a simple, safe and wear-free manner.

This avalanche probe comprises at least a first and a second tubular probe part that can be brought into plug connection, a connecting cord situated inside the probe parts, one end of which is in connection with the first probe part, and the other end of which is in connection with a tensioning apparatus, wherein the connecting cord is tensionable by means of the tensioning apparatus and is fixable in a clamping apparatus situated on the second probe part in such a manner that, in a tensioned state, all probe parts are held against one another in plug connection and, in an untensioned state, the probe parts are movable relative to one another. In the present invention, the clamping apparatus comprises an inner sleeve, having a first channel through which the connecting cord passes, and an outer sleeve, having a second channel in which the inner sleeve is slidably situated in such a manner along a longitudinal axis of the outer sleeve that the inner sleeve can be brought from a release position to a clamping position in which at least one clamping element engages the first channel in such a manner that the connecting cord running through the first channel is fixedly held in the clamping apparatus.

Accordingly, the advantage of the apparatus can be particularly seen in that the clamping apparatus for fixing the connecting cord consists, in essence, of three parts, namely the inner sleeve, the clamping element and the outer sleeve. The connecting cord running through the inside of the probe is fed through the inner sleeve. The inner sleeve can be slid back and forth along the longitudinal axis of the outer sleeve. If the inner sleeve is located in the clamping position, then a clamping element engages the second channel via the wall of the inner sleeve and thus fixes the connecting cord.

Particularly advantageous in this case is that a simple sliding motion from the release position into the clamping position suffices to fix the connecting cord. If the tensioning force of the connecting cord acts so as to automatically bring the inner sleeve into the clamping position via appropriate friction, the clamping apparatus can fix the tensioned connecting cord without further manipulation.

Preferably, the inner sleeve comprises at least one recess that connects the first and second channels and respectively receives a clamping element. This recess can be, for example, a bore that has been formed through the wall of the inner sleeve at a right angle to the longitudinal axis of the second channel. In this manner, the relative motion between the inner sleeve and the outer sleeve that occurs during a sliding from the release position to the clamping position can be used to redirect the clamping element via the recess in the direction of the connecting cord and to exert the fixing force on the connecting cord.

Preferably, the inner sleeve comprises exactly three mutually opposite-lying clamping elements. The three clamping elements are situated in a plane orthogonal to the longitudinal axis of the second channel and preferably form, in respective pairs with the midpoint of the second channel, essentially identically large angles. A cord tensioned in this manner is securely held, yet can be easily released from the tensioned position since each of the three clamping elements exerts an equal force.

In the manufacturing of avalanche probe, it is beneficial and advantageous to manufacture the individual elements from materials that do not rust. The clamping elements are preferably manufactured from plastic.

Preferably, the clamping element comprises a sphere. This sphere that is situated in the aforementioned recess glides along the inner wall of the outer sleeve without substantial friction during a sliding of the inner sleeve from the clamping position into the release position and back again. Thus, due to the marginal friction, this motion requires only minor effort.

Preferably, the diameter of the sphere is larger than the thickness of the wall of the inner sleeve in the direct vicinity of the respective recess so that the sphere is clampable between the outer sleeve and the connecting cord. This means that the sphere is dimensioned to be so large that it protrudes either into the first channel or into the second channel, or partially into both channels. In this manner, force can be exerted via the sphere onto the connecting cord running through the first channel. This force serves to fix the connecting cord when tensioned.

Preferably, the diameter of the sphere is larger than or equal to that of the connecting cord. Preferred dimensions of the connecting cord are, in the case of a metal cable, roughly 1.6 mm and, in the case of a Kevlar cable, roughly 2 mm. Accordingly, the spheres exhibit a diameter of roughly 2.5 mm to 3.0 mm. Through the use of advantages ratios between the cord and sphere diameter, a secure clamping can be ensured, particularly when three spheres are used that are mutually oppositely situated in a plane.

Preferably, the second channel of the outer sleeve comprises a section that conically tapers in the direction of the first probe part and that forms a ramp in the radially inward (axial) direction of the second channel, which ramp tensions at least one clamping element in the direction of the connecting cord during motion of the inner sleeve from the release position into the clamping position. Thus, at least one clamping element, e.g. the sphere held in the recess, glides up the ramp during this motion of the inner sleeve and is thus increasingly pressed in the axial direction of the second channel. The fixing operation carried out in this manner can be reversed via a motion of the inner sleeve from the clamping position into the release position. The sphere/clamping element glides down the ramp, away from the longitudinal axis, and increasingly gains play and no longer fixes the cord.

Advantageously, an outer wall of the inner sleeve comprises at least one conical section in which at least one clamping element is situated and that is formed essentially parallel to the conical section of the outer sleeve. Thus, in the clamping position, a conical section of the outer sleeve lies respectively opposite a conical section of the inner sleeve.

To avoid losing functionality of the clamping apparatus due to dirt or icing, it has at least one seal that seals the first and second channels from the ambient environment. Preferably, several seals are configured such that a transporting of dirt or moisture into the interior of the clamping apparatus is not possible via either the relative motion of the connecting cord or the motion of the inner sleeve relative to the outer sleeve from the clamping position to the release position and back.

If a spring element of the clamping apparatus biases the inner sleeve into the clamping position, then an automatic fixing of the connecting cord is effected. If the connecting cord is further tensioned, then the tensioning motion preferably acts counter to the spring force and brings the inner sleeve from the clamping position into the release position. After the tensioning of the connecting cord, the inner sleeve, driven by the spring element, returns to the clamping position. Preferably, the spring element is a helical spring or a conical helical spring.

To easily undo the fixing of the connecting cord, an actuating handle can be provided on the outer end of the inner sleeve facing away from the second probe part, by means of which the inner sleeve can be brought from the clamping position into the release position.

To simplify operation of the actuating handle, a grip can be provided on the second probe part to assist in tensioning the cord and in pulling the inner sleeve to the release position. This is particularly advantageous when one considers that the probes are used in snow and ice and that, accordingly, the users usually wear gloves.

Preferably, the outer sleeve comprises a stopping apparatus that limits a motion of the inner sleeve, at least in a tensioned state, opposite the tensioning action of the connecting cord. Such a stopping apparatus is configured and adapted such that a seizing or wedging of the inner sleeve in the first channel particularly due to the conical tapering of the outer sleeve is precluded. As a result, the motion of the inner sleeve is as smooth-running as possible.

The inner sleeve can include at least one notch opposed to each of the clamping elements for fixing reception of the connecting cord in the clamping position.

To ensure simple maintenance of the clamping apparatus, an adapter into which the clamping apparatus can be detachably screwed can be provided on the second probe part. For example, this adapter can be glued to the second probe part. Instead of a screwing of the clamping apparatus into the adapter or even directly into the probe part, a snapping mechanism for securing the clamping apparatus in the adaptor is also conceivable.

Further details, advantages and embodiments of the invention can be taken from the following description of two preferred embodiments with reference to the drawings.

### BRIEF DESCRIPTION OF THE DRAWINGS

FIG. 1 is a partially exploded isometric view of a prior art avalanche probe with a clamping apparatus.

FIG. 2a is an exploded isometric view of a portion of the avalanche probe of FIG. 1 which has a clamping apparatus of one embodiment of the present invention.

FIG. 2b is an exploded isometric view of a portion of the avalanche probe of FIG. 1 which has a clamping apparatus of another embodiment of the present invention.

FIG. 3a is a cross-section view of the clamping apparatus shown in FIG. 2a.

FIG. 3b is a cross-section view of the clamping apparatus shown in FIG. 2b.

### DETAILED DESCRIPTION OF PREFERRED EMBODIMENTS

In following discussion of the figures illustrating the avalanche probe, the same reference numbers are used for identical and functionally identical parts.

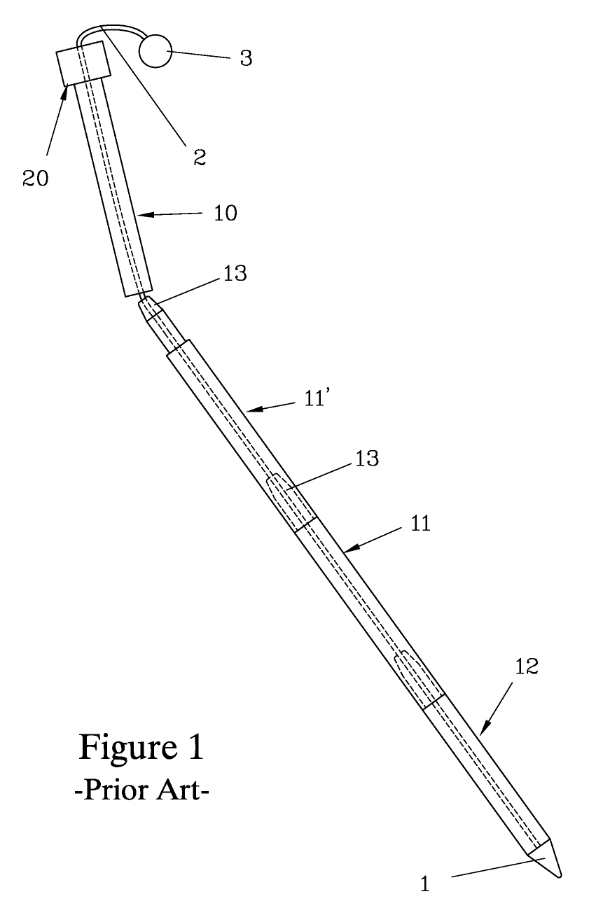

As noted in the background section of the application, FIG. 1 is a representation of a prior art collapsible avalanche probe. The avalanche probe has several tubular probe parts 10, 11, 11′ and 12 that can be plug-connected to one another. A first probe part 12 and a second probe part 10 (not shown in its plug-connected position) respectively form the beginning and the end of the probe, and can be stuck together with the intermediate probe sections (11, 11′) attached therebetween. While only two intermediate probe sections (11, 11′) are shown in FIG. 1, it is typically preferred to employ more to reduce the length of the probe parts; however, a two-part probe could be employed using only the first probe part 12 and the second probe part 10. To allow easier insertion of the probe into the snow, a tip 1 is attached at an extreme end of the first probe part 12. A clamping apparatus 20 is located on the second probe part 10 that forms the other end of the avalanche probe. A connecting cord 2 runs in the interior of the probe parts (10, 11, 11′, 12). The connecting cord 2 is fixedly connected, via the one end, to the first probe part 10 and can be tensioned via a tensioning apparatus 3 mounted on the other end which can be grasped by the user and pulled to apply tension to the connecting cord 2. The tensioned connecting cord 2 runs through the interior of the clamping apparatus 20 and is fixed in its tensioned state by means of the clamping apparatus 20.

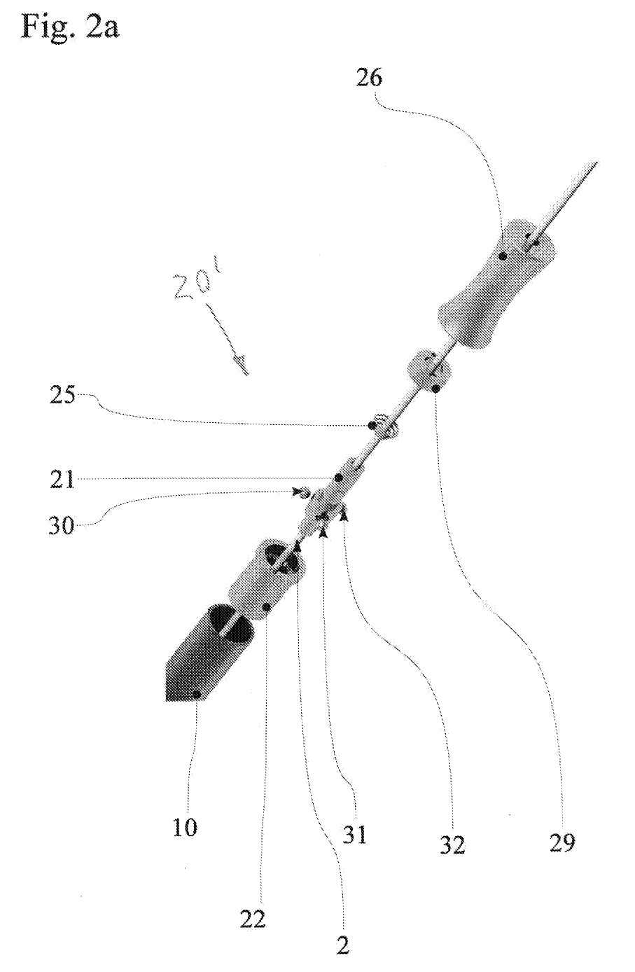

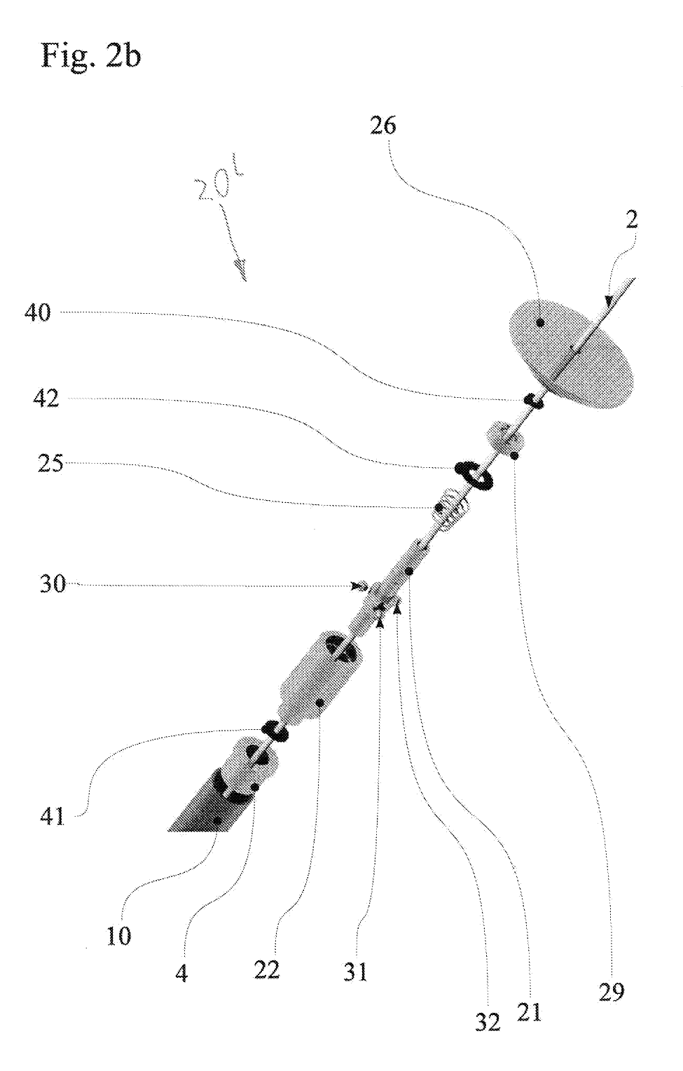

FIG. 2a illustrates an exploded view of a first embodiment of an improved clamping apparatus 20′. This figure shows the end section of the second probe part 10 from which the connecting cord 2 extends. The connecting cord 2 runs through an inner sleeve 21 of the clamping apparatus 20′. Further constructional elements of the clamping apparatus 20′ shown here are an outer sleeve 22, three spheres (30, 31, 32) that form the clamping elements of this embodiment, a conical helical spring 25, an annular cap 29 for closing off the outer sleeve 22, as well as an actuating handle 26.

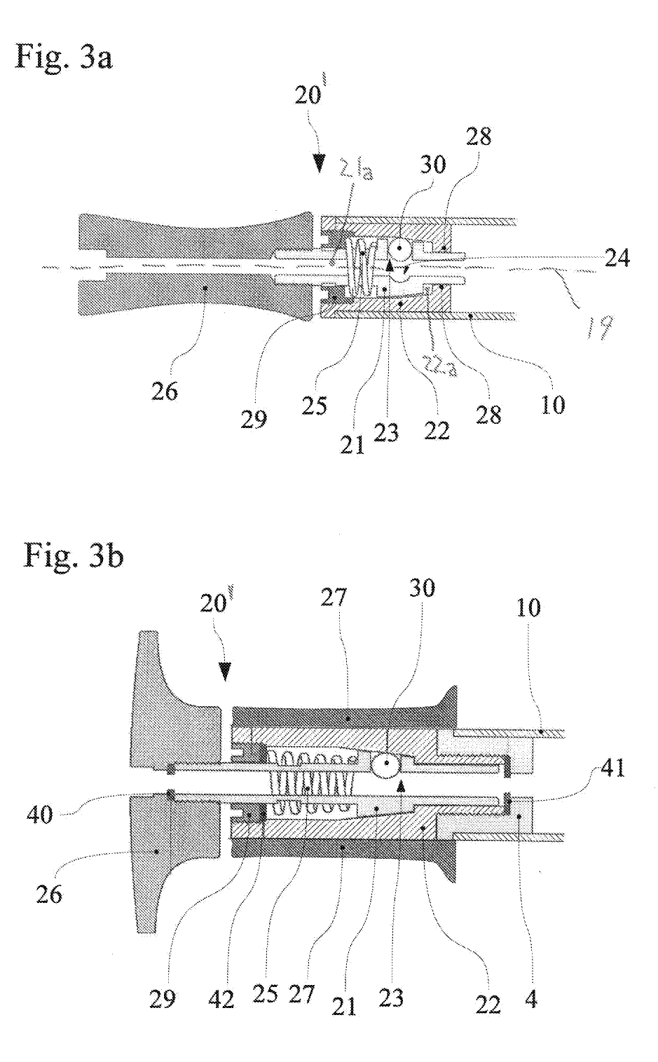

The function and position of the individual constructional elements of the clamping apparatus 20′ shown in FIG. 2a can be better understood by viewing FIG. 3a, which illustrates the assembled clamping apparatus 20′ in cross-section along a longitudinal axis 19 of the second probe part 12. The clamping apparatus 20′ is situated, in this case, largely inside the second probe part 10. The outer sleeve 22 is situated inside, parallel to the longitudinal axis 19 of the second probe part 10, and is fixedly glued to same, pressed into it, or otherwise affixed therein. In turn, the inner sleeve 21 is situated in the inside of the outer sleeve 22, residing in a second channel (22a) of the outer sleeve 22. The inner sleeve 21 is also parallel to the longitudinal axis 19 of the second probe part 10. When the inner sleeve 21 is moved along this longitudinal axis 19, it can be brought from a clamping position, in which the inner sleeve 21 projects further into the interior of the second probe part 10, into a release position, where the projection of the inner sleeve 21 into the interior of the second probe part 10 is reduced. The annular cap 29 is screwed into a thread of the outer sleeve 22 and clasps around the inner sleeve 21 in such a manner that the outer end of the outer sleeve 22 is closed off. The conical helical spring 25 engages the inner sleeve 21 and the annular cap 29 of the outer sleeve 22 in such a manner that the spring force holds the inner sleeve 21 in the clamping position. In order to counteract this spring force to bring the inner sleeve 21 from the clamping position into the release position, an actuating handle 26 which can be readily grasped and pulled by the user is provided at the outermost end of the inner sleeve 21. For simple maintenance of the clamping apparatus 20, the cap 29 can be threadably removed.

An inner (first) channel (21a) runs along the longitudinal axis 19 in the interior of the inner sleeve 21 as well as through the actuating handle 26. The connecting cord 2 passes through the inner channel (21a), as shown in FIG. 2a. The sphere 30 is situated in a recess 23 that traverses a section of the inner sleeve 21. This sphere 30 is dimensioned such that it projects above the recess 23. The outer sleeve 22 is formed with a conical ramp extending in the direction of the longitudinal axis 19 of the second probe part 10; thus, the second channel (22a) of the outer sleeve 22 tapers in such a manner that, when the inner sleeve 21 is in the clamping position, the sphere 30 projects into the first channel (21a) of the inner sleeve 21 and thus fixes the connecting cord 2 which passes therethrough (cf. FIG. 2a). In the release position, the sphere 30 has more play between the inner sleeve 21 and the outer sleeve 22, and thus the sphere 30 is not pressed into the first channel (21a) of the inner sleeve 21 when the inner sleeve 21 is in the release position. Preferably, the inner sleeve 21 is formed with a conically tapered portion that parallels the conical ramp of the outer sleeve 22. In order to avoid jamming of the inner sleeve 21 against the conically tapered outer sleeve 22, a stopping apparatus 28 is provided at the inner end of the outer sleeve 22. When the connecting cord 20 has a somewhat deformable cross section, a notch 24 can be provided in the inner sleeve 21 positioned opposite the recess 23 to more securely fix the cord in the clamping position. However, such a notch 24 may make release of the connecting cord 2 more difficult.

Although only one sphere 30 is depicted in the cross-section view of FIG. 3a, three spheres (30, 31, 32) with corresponding recesses 23 are provided, as can be discerned from FIG. 2a. Due to the tapering of the second channel (22a) of the outer sleeve 22, each of the three spheres (30, 31, 32) is pressed first channel (21a) of the inner sleeve 21 when the inner sleeve 21 is in the clamping position. Thus, in the clamping position, the connecting cord 2 (shown in FIG. 2a) is jammed between the three spheres (30, 31, 32).

FIGS. 2b and 3b show a second embodiment of the improved clamping apparatus 20′ for use in the collapsible avalanche probe shown in FIG. 1. Analogous to FIGS. 2a and 3a, FIG. 2b shows an exploded isometric view, and FIG. 3b shows a cross-section of the assembled clamping apparatus 20′. These Figures show a connecting cord 2, an actuating handle 26, a conical helical spring 25, an inner sleeve 21, three spheres (30, 31, 32) that serve as clamping elements, an annular cap 29 and an outer sleeve 22. Additionally, the second embodiment of the clamping apparatus 20′ has an adapter 4 that is fixed into the end of the second probe part 10. The adapter 4 serves as a coupling piece between the second probe part 10 and the clamping apparatus 20′. The clamping apparatus 20′ is removably screwed into the adapter 4.

The second embodiment of the clamping apparatus 20′ furthermore comprises a first seal 40, a second seal 41, and a third seal 42. These seals (40, 41, 42) serve to prevent the ingress of snow and other contaminants into the clamping apparatus 20′. As can be seen from FIG. 3b, the first seal 40 is situated at the outer end of the inner sleeve 21, facing away from the second probe part 10, and is formed in such a manner that it clasps around the connecting cord 2 (cf. FIG. 2b). The second seal 41 is situated at the inner end of the outer sleeve 22 and also clasps around the connecting cord 2. The third seal 42 is situated at the outer end of the outer sleeve 22 and clasps around the inner sleeve 21. Since the inner sleeve 21 projects from the outer sleeve 22 in order to receive the actuating handle 26 over the outer sleeve 22 at the end thereof that faces away from the probe part 10, the third seal 42 is necessary to close off a gap between the inner sleeve 21 and the outer sleeve 22.

As regards the second embodiment of the clamping apparatus 20′, it should also be noted that the actuating handle 26 of this embodiment has an umbrella-shaped form and a grip 27 is provided on the outer wall of the outer sleeve 22 for improving the operability of the actuating handle 26 by allowing the user to more readily grasp the outer sleeve 22 when pulling the actuating handle 26 to move the inner sleeve to the release position.

While the novel features of the present invention have been described in terms of particular embodiments and preferred applications, it should be appreciated by one skilled in the art that substitution of materials and modification of details obviously can be made without departing from the spirit of the invention.

What I claim is:

1. An improved avalanche probe having,
at least a first and a second tubular probe part that can be aligned and brought into plug connection with each other, and
a connecting cord situated inside the probe parts, one end of which is in connection with the first probe part, and the other end of which is in connection with a tensioning apparatus,
wherein the connecting cord is tensionable by means of the tensioning apparatus and is fixable in a clamping apparatus situated on the second probe part such that, in a tensioned state, all probe parts are held in alignment against one another in plug connection and, in an untensioned state, the probe parts are movable relative to one another,
the improvement residing in the clamping apparatus which comprises:
an inner sleeve having a first channel through which the connecting cord passes, and
an outer sleeve having a second channel in which said inner sleeve is slidably situated in such a manner as to move along a longitudinal axis of said outer sleeve so that said inner sleeve can be brought from a release position to a clamping position in which at least one clamping element engages said first channel in such a manner that the connecting cord running through said first channel is fixedly held in the clamping apparatus.

2. The improved avalanche probe of claim 1 wherein said inner sleeve has at least one recess that connects said first and second channels and respectively receives said at least one clamping element.

3. The improved avalanche probe of claim 2 wherein said inner sleeve has exactly three mutually opposed recesses that each receive one of said clamping elements such that said clamping elements lie in a plane perpendicular to said longitudinal axis.

4. The improved avalanche probe of claim 3 wherein each of said clamping elements is manufactured from plastic.

5. The improved avalanche probe of claim 4 wherein each of said clamping elements is a sphere.

6. The improved avalanche probe of claim 5 wherein the diameter of said sphere is larger than the thickness of an inner sleeve wall of said inner sleeve in the direct vicinity of said recesses so that said sphere is clampable between said outer sleeve and the connecting cord.

7. The improved avalanche probe of claim 6 wherein the diameter of said sphere is at least as large as that of the connecting cord.

8. The improved avalanche probe of claim 7 wherein said second channel of said outer sleeve has a section that conically tapers in the direction of the first probe part and that forms a ramp in the axial direction of said second channel, which ramp forces said clamping elements in the direction of the connecting cord during motion of said inner sleeve from the release position into the clamping position.

9. The improved avalanche probe of claim 8 wherein an outer wall of said inner sleeve has at least one conical section in which said clamping elements are situated and that is formed essentially parallel to said conical section of said outer sleeve.

10. The improved avalanche probe of claim 9 wherein the clamping apparatus further comprises:
at least one seal that seals the clamping apparatus from the ambient environment.

11. The improved avalanche probe of claim 10 wherein said at least one seal further comprises:
at least one inner sleeve seal positioned at least one end of said inner sleeve to seal said first channel from the ambient environment; and
at least one outer sleeve seal positioned at least one end of said outer sleeve to seal said second channel from the ambient environment.

12. The improved avalanche probe of claim 8 wherein the clamping apparatus further comprises:
a spring element that biases said inner sleeve to the clamping position.

13. The improved avalanche probe of claim 12 wherein said spring element comprises a helical spring.

14. The improved avalanche probe of claim 8 wherein said inner sleeve further comprises:
an actuating handle formed on an outer end of said inner sleeve facing away from the second probe part, by means of which said inner sleeve can be brought from the clamping position into the release position.

15. The improved avalanche probe of claim 14 wherein the second probe part has a grip for simplifying operation of said actuating handle.

16. The improved avalanche probe of claim 8 wherein said outer sleeve further comprises:
a stopping apparatus that limits a motion of said inner sleeve, at least in a tensioned state, opposite the tensioning action of the connecting cord to prevent seizing of said inner sleeve against said outer sleeve.

17. The avalanche probe of claim 8 wherein said inner sleeve further comprises:
at least one notch for fixing reception of the connecting cord in the clamping position.

18. The avalanche probe in accordance of claim 10 wherein the second probe part comprises an adapter for releasable mounting of the clamping apparatus.
